(19) United States
(12) Patent Application Publication
(10) Pub. No.: US 2023/0326480 A1
(43) Pub. Date: Oct. 12, 2023

(54) COMMON WORD DETECTION AND TRAINING RECOGNITION

(71) Applicant: SITE VANTAGE, INC., Westport, CT (US)

(72) Inventors: Shawn Bonnington, Trinity, FL (US); Adnan Aziz, Frisco, TX (US)

(21) Appl. No.: 17/716,734

(22) Filed: Apr. 8, 2022

(51) Int. Cl. G10L 25/72; G10L 15/08

(52) U.S. Cl. CPC G10L 25/72; G10L 15/08; G10L 2015/088

(57) ABSTRACT

Systems and methods to provide training content to conference users, such as users discussing their operation of equipment. The conference can be an audio/video conference or include only audio. Sensor data is captured during a user's operation of the equipment. The sensor data is analyzed to detect an event in the operation of the equipment. An audio file is obtained for conference where the user's operation of the equipment is discussed. The audio file is analyzed to generate a list of words or phrases used during the conference. In response to detecting an event in the sensor data, training content for the event is selected based on the event type and at least one word or phrase being used a threshold number of times during the conference. The training content is then provided or presented to the user to avoid the event.

### TECHNICAL FIELD

The present disclosure relates generally to digital content presentation and, more particularly, to monitoring an audiovisual conference for common words to select and provide recommended training content.

### BACKGROUND

### Description of the Related Art

Today's working environment has been merging into a more dynamic situation, where many workers are working remotely from one another. In some situations, some workers may be in an office that is in a different city or state from another office. In other situations, some workers may be working from home. These remote working environments has caused many businesses to re-shape how people are trained and how teams have meetings. Many of these business operations now involve on-line video conference systems, where workers can gather in virtual meeting rooms to communicate with one another. Some of these situations allow users to record the virtual meetings, but individual effort is often required to access or re-evaluate the meeting from these recordings. It is with respect to these and other considerations that the embodiments described herein have been made.

### BRIEF SUMMARY

Briefly described, embodiments are directed toward systems and methods of providing training content to equipment operators based on common or repeat word usage during a conference. The conference can be audio conference call, video conference, which includes audio, a social media based conference or any other electronic conference. Sensor data associated with a user's operation of a piece of equipment or type of equipment is received. An event is detected based on an analysis of the sensor data and an event type is identified for the event. At some time before or after the user's operation of the equipment, audio file is obtained for a video conference. The video conference may include the user and one or more other people, or it may not include the user. In some embodiments, the video conference involves people discussing the user's operation of the equipment. The audio file is analyzed for words or phrases and a list of words or phrases used during the video conference is generated from the analysis of the audio file. At least one word or phrase is identified from the list of words or phrases that is used a number of times that exceeds a selected threshold. Training content associated with the at least one identified word or phrase and the event type is selected and presented to the user. In some embodiments, a suggestion for modifying the equipment may be generated and provided to an administrator based on the event type and the at least one identified word or phrase.

In some embodiments, words or phrases used by the presenter of the video conference are identified and added to the list of words or phrases. In other embodiments, words or phrases used by the user of the equipment and added to the list of words or phrases. The list of words or phrases may be generated based on reoccurring known words or phrases associated with the equipment. The list of words or phrases may include a plurality of separate known words that are spoken during the video conference, a plurality of phrases that each contain a plurality of sequential words that are spoken during the video conference, a plurality of phrases that each contain a plurality of non-sequential words associated a known part of the equipment that are spoken during the video conference, or some combination thereof.

Embodiments described herein can improve the operation of the equipment, extend the longevity of the equipment or its parts, improve user performance, and even improve the operation of the various computing components of the system. For example, by analyzing a video conference audio file for commonly used words or phrases, the system can detect issues with the equipment or training of the user prior to user or equipment error or failure. Reducing user or equipment errors or failures can lead to fewer events being detected by the system and thus reduced computer resource utilization and data transfers in selecting and providing training content to users.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for tracking and utilizing user-equipment data and video conferences to provide training content to a user in accordance with embodiments described herein;

FIG. 2 is a context diagram of non-limiting embodiments of systems for tracking and utilizing user-equipment data and analyzing video conference data to provide training content to a user in accordance with embodiments described herein;

FIG. 3 illustrates a logical flow diagram showing one embodiment of a process for analyzing video conference audio data to detect common words and to provide training content to a user in accordance with embodiments described herein;

FIG. 4 illustrates a logical flow diagram showing one embodiment of a process for analyzing video conference audio data to detect common words, as well as analyzing equipment sensor data, to provide training content to a user in accordance with embodiments described herein; and

FIG. 5 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

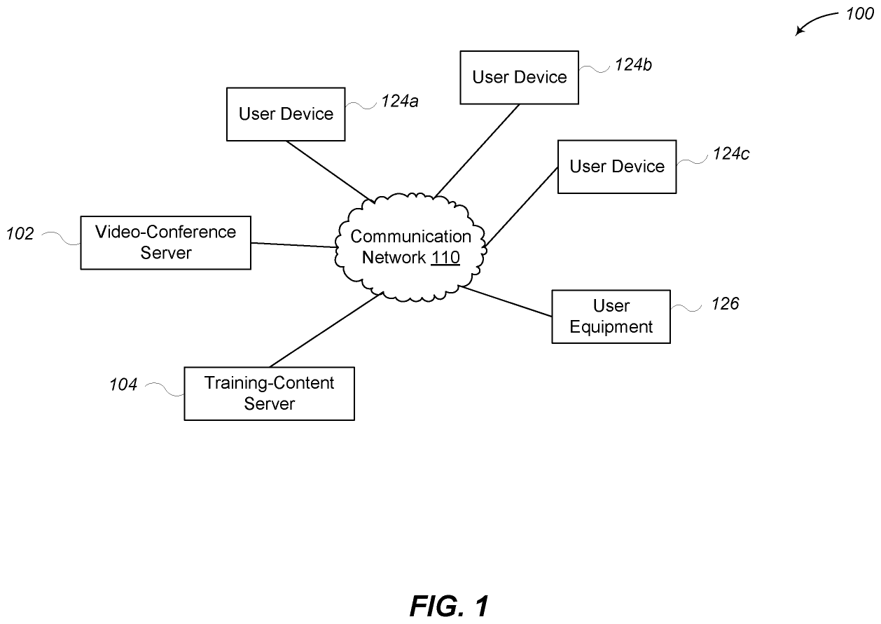

FIG. 1 illustrates a context diagram of an environment for tracking and utilizing user-equipment data and video conferences to provide training content to a user in accordance with embodiments described herein. Environment 100 includes a training-content server 104, user equipment 126, user devices 124a-124c (also referred to as user devices 124 or user device 124), and a video-conference server 102. Although FIG. 1 illustrates three user devices 124a-124c, embodiments are not so limited. Rather, one or more user devices 124 may be included in environment 100. Similarly, although FIG. 1 illustrates one user equipment 126, embodiments are not so limited and one or more user equipment 126 may be included in environment 100. In some embodiments, the user equipment 126 may be optional and may not be included.

The video-conference server 102 is configured to maintain, host, or otherwise coordinate a video conference between two or more computing devices, such as user devices 124a-124c, via communication network 110. Communication network 110 includes one or more wired or wireless networks in which data or communication messages are transmitted between various computing devices.

The video conference may be between multiple participants using one or more user devices 124a-124c, the video-conference server 102, the training-content server 104, or other computing devices, or some combination thereof. In various embodiments, the video-conference server 102 records a video file, audio file, or an audiovisual file of the video conference, which may be referred to as video conference data. The conference can also be an audio only conference call, such as a standard mobile phone call. In can also be a conference in which some of the participants might be audio only, while others are participating with both audio and video. Some conference services, such as Zoom, GoToMeeting, Microsoft Teams, FaceTime, Google Meet, etc. that permit audio only for some participants and audio/video for others. While the term, video conference is used herein as one embodiment, the general term conference includes any type of conference that includes audio, even if video is not provided from so or all of the participants. In other embodiments, the computing device hosting the video conference, such as a user device 124, may record the video conference and provide a copy of the video file, the audio file, or the audiovisual file of the video conference to the video-conference server 102.

The video conference may include a plurality of participants. In some embodiments, the participants may include the user and one or more other people, such as other users, an administrator, a supervisor, a presenter, or other person that has knowledge of the user equipment, the user, or the user's operation of the user equipment. In other embodiments, the video conference may include a plurality of participants, not including the user. In at least one such video conference, the participants may be discussing the user's operation of the equipment without the presence or knowledge of the user. Although embodiments are described with respect to a video conference that includes video and audio, embodiments are not so limited. In some embodiments, the conference may be an audio conference that includes only audio content. In at least one embodiment, the video or audio conference may be referred to as an inter-computer digital conference.

The user devices 124a-124c are computing devices that can host or otherwise connect to a video conference. In some embodiments, the video conference is hosted by the video-conference server 102. In other embodiments, a user device 124 may host the video conference. The user devices 124a-124c can also receive training content and present it to a user. Examples of user devices 124a-124c may include, but are not limited to, mobile devices, smartphones, tablets, laptop computers, desktop computers, or other computing devices that can communication with other user devices 124, the video-conference server 102, the training-content server 104, or some combination thereof. In various embodiments, the user devices 124 may be separate or remote from the user equipment 126 and may not be included in the operation of the user equipment. In other embodiments, a user device 124 may be integrated or embedded in each separate user equipment 126.

The training-content server 104 obtains at least the audio file of the video conference from the video-conference server 102 via communication network 110. The training-content server 104 analyzes the audio file for common words or phrases that are repeated or used often throughout the video conference. In some embodiments, the training-content server 104 generates a list of each word or phrase that is spoken during the video conference and identifies those words or phrases that are used more than a threshold number of times, i.e., commonly used words or phrases during the video conference. The training-content server 104 uses these identified words or phrases to select training content that is to be presented to the user. For example, the training-content server 104 may determine that the word “clutch” is used 43 times in a 30-minute video conference. If the selected word threshold is 12, then the word “clutch” may be identified as a reoccurring word that exceeds the selected threshold. The training-content server 104 then selects training content associated with proper clutch usage to present to the user.

In some embodiments, a first threshold may be used to assess whether words are being commonly used and a second, different threshold may be used to assess whether phrases are being commonly used. In yet other embodiments, one or more different thresholds may be used for different groupings of words or phrases. For example, a first threshold may be used for words or phrases regarding known words (e.g., known words associated with a piece of equipment or a type of equipment) and a second threshold may be used for other words or phrases.

In various embodiments, the training-content server 104 may receive a video file of the video conference. The training-content server 104 may perform one or more graphical text analysis on the video file to identify commonly used words or phrases, similar to what is described herein with respect to the analysis of the audio file. The training-content server 104 can then select and present training content based on these commonly used visual words or phrases.

In some embodiments, the training-content server 104 may itself present the selected training content to the user. In other embodiments, the training-content server 104 may provide the selected training content to a user device 124 via communication network 110 for presentation to the user. In yet other embodiments, the training-content server 104 may provide the selected training content to the video-conference server 102 via communication network 110 to be presented to the user via another video conference. In at least one embodiment, the training-content server 104 may perform its analysis in real time as the video conference is ongoing. If a word or phrase is detected as exceeding the threshold number, then the training-content server 104 can select and provide training content associated with the detected word or phrase to the user during the same video conference.

In various embodiments, multiple separate video conferences for the same or different users may be analyzed to identify reoccurring words or phrases across a plurality of separate video conferences. If those words or phrases are repeated a selected number of times across multiple video conferences, then the training content may be selected based on those repeating words or phrases and the selected training content may be provided to a plurality of users. In various embodiments, the training-content server 104 can select the training content based on a combination of the reoccurring word or phrase usage and the detection of an event in sensor data associated with the user equipment 126 being operated by the user.

The user equipment 126 may be any type of equipment or machinery that is operable by a user such that the equipment's operation or performance is influenced by user input or involvement. Each user equipment 126 may include one or more sensors (not illustrated). These sensors collect data regarding some aspect of the user equipment 126 as the user equipment 126 is being operated by the user.

In some embodiments, the user equipment 126 includes mobile equipment, such as bulldozers, backhoes, semi-trucks, snowplows, dump trucks, or other mobile equipment operated by a user. In other embodiments, the user equipment 126 may include non-mobile equipment, such as rock crushing systems, conveyer-belt systems, factory-plant systems or equipment, or other types of non-mobile equipment operated by a user. In various embodiments, the user equipment 126 may include a combination of mobile equipment and non-mobile equipment. The above examples of user equipment 126 are for illustrative purposes and are to be not limiting.

Each user equipment 126 may be referred to as an individual and specific piece of equipment or may be of a particular equipment type, or both. For example, a first user equipment may have an equipment type of bulldozer and an individual equipment identifier as BullDozer_123. In comparison, a second equipment may have an equipment type of rock crushing system, but not individually identifiable from other systems of the same type. In some embodiments discussed herein, the training content provided to a user of the equipment may be tailored for the specific piece of equipment or for the particular equipment type.

The training-content server 104 can collect the sensor data from each user equipment 126 via communication network 110. The training-content server 104 analyzes the sensor data to detect events that occurred while users are operating the user equipment 126. In some embodiments, this detection may be in real time as sensor data is being captured during the users' operation of the user equipment 126, which may trigger the need or scheduling of a video conference between the user and a supervisor. In other embodiments, the event detection may be post-operation or delayed depending on access to the communication network 110, such as prior to, during, or after a video conference is recorded regarding the user's operation of the user equipment.

Examples of detected events may include, but are not limited to, improper gear shifting, unsafe driving speeds, improper use of equipment or equipment accessories (e.g., positioning the accessory in an incorrect position or arrangement, picking up too heavy of a load, etc.), visual or audio warnings being presented by the equipment, user body movements while the equipment is being operated (e.g., a user pushing a button or manipulating a switch, a user ignoring a visual or audio warning in the equipment, etc.), or other types of events. As discussed herein, the events may be detected by the value or values of sensor data from a single sensor or from a combination of sensors. Moreover, the events may be based on a single sensor data values or trends in the sensor data over time.

After the training-content server 104 detects an event, the training-content server 104 selects training content to provide to the user that was operating the user equipment 126 when the sensor data was collected that resulted in the event. As mentioned herein, the training-content server 104 selects the training content based on a combination of the type of event detected and the word or phrase usage during a video conference. In some embodiments, the training-content server 104 provides the training content to the user equipment 126 via the communication network 110 for presentation to the user through a user interface of the user equipment 126. For example, the user equipment 126 may include a head unit, display device, audio system, or other audiovisual system to present the training content to the user. In at least one embodiment, the operation of the user equipment 126 by the user may be paused or locked until the user consumes (e.g., watches, reads, or listens to) the training content.

In various embodiments, the training-content server 104 can generate an equipment modification recommendation based on the event type and the reoccurring word or phrase usage during the video conference. For example, assume multiple users have had difficulty engaging a particular button on the equipment, which is repeatedly detected as an event because of improper operation due to failure to engage the button and the button is regularly discussed during one or more video conferences. The training-content server 104 can generate a suggestion to modify the button based on the repeated event detection and common discussion of the button. This suggestion may be presented to the user, an administrator, or an equipment maintenance individual or an audiovisual interface (not illustrated) of the training-content server 104 or some other computing device.

In various embodiments, sensor data from a plurality of users or a plurality user equipment 126 may be aggregated to detect events or select training content. For example, if an event is detected for each of a plurality of different users that are operating as same piece of user equipment 126 and at least one of those users participates in a video conference where a reoccurring word or phrase associated with the event is detected, then the training content may be selected and provided to each of those plurality of users to educate the plurality of users on how to properly operate that piece of equipment. As another example, if an event is detected for each of a plurality of different pieces of user equipment 126 of a same equipment type and at least one user has participated in a video conference where a reoccurring word or phrase associated with the event is detected regarding that equipment type, then the training content may be selected for that equipment type and provided to users that operate that type of equipment. As yet another example, if a similar event is detected for each of a plurality of different types of user equipment 126 that have a same feature and that same feature is discussed in at least one video conference, then the training content may be selected for that feature and detected event and provided to users that operate any type of equipment having that feature.

In various embodiments, the training-content server 104 may also track the success of the selected training content over time or issues with the equipment 126. In some embodiments, an indication of whether the user consumed the training content may be obtained. If the user consumed the training content and an event associated with the training content re-occurs then the training content may have been unsuccessful at training the user to avoid the event. Similarly, if a follow-up video conference is performed and usage the same or similar word or phrase exceeds the selected threshold, then the training may be labeled as unsuccessful. But if the user did not consume the training content, then the training content may be re-provided to the user in response to another detection of the same or similar event.

In other embodiments, a history of events for particular equipment or for a plurality of equipment may be analyzed for issues with the equipment, rather than the users operating the equipment. For example, if a same or similar event is detected for a plurality of different equipment of a same type, then the training-content server 104 can determine that there is an issue with that equipment type.

Although these embodiments are described with respect to using equipment sensor data and video conference word usage to select training content, embodiments are not so limited. In some embodiments, only the video conference word or phrase usage is used to select the training content. In other embodiments, other equipment usage or failure information, along with the video conference word or phrase usage, may be used to select and provide the training content to one or more users.

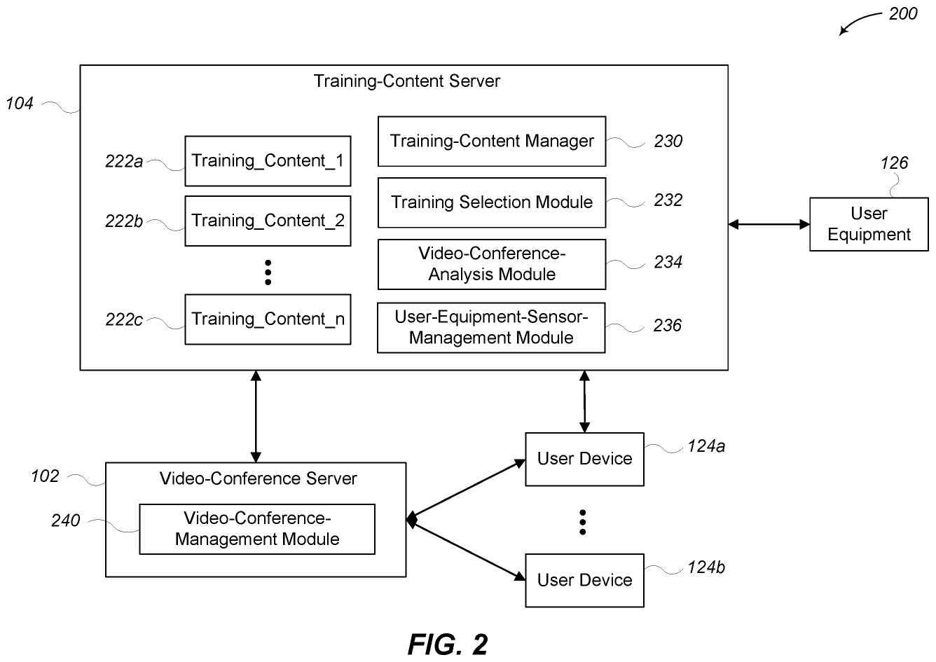

FIG. 2 is a context diagram of non-limiting embodiments of systems for tracking and utilizing user-equipment data and analyzing video conference data to provide training content to a user in accordance with embodiments described herein.

Example 200 includes a training-content server 104, a video-conference server 102, a user equipment 126, and user devices 124a-124b, which are generally discussed above in conjunction with FIG. 1. In this illustrative example, the user of user device 124a is the user of the user equipment 126 and the user of user device 124b is a supervisor of the user of the user equipment 126.

The video-conference server 102 includes a video-conference-management module 240. The video-conference-management module 240 is configured to manage or maintain video conferences, as discussed herein. For example, the video-conference server 102 may host a video conference for user devices 124a-124b. The video-conference-management module 240 may record, store, or otherwise obtain a copy of the video conference.

The training-content server 104 includes a training-content manager 230, a training selection module 232, a video-conference-analysis module 234, and optionally a user-equipment-sensor-management module 236. The training-content server 104 also stores a plurality of training content 222a-222c. Although illustrated as a single server, training-content server 104 may include one or more computing devices. For example, the plurality of training content 222a-222c may be stored on a computing device that is separate from the training-content manager 230, the training selection module 232, the video-conference-analysis module 234, and the user-equipment-sensor-management module 236.

Moreover, although FIG. 2 illustrates the training-content manager 230, the training selection module 232, the video-conference-analysis module 234, and the user-equipment-sensor-management module 236 as separate components of the training-content server 104, embodiments are not so limited. In various embodiments, one or a plurality of components, managers, or modules may be employed on one or more computing devices to perform the functionality of the training-content manager 230, the training selection module 232, the video-conference-analysis module 234, and the user-equipment-sensor-management module 236.

The training-content manager 230 is configured to manage the plurality of training content 222a-222c. In some embodiments, the training-content manager 230 stores a table or other data structure that maps the plurality of training content 222a-222c to one or more known words or phrases that may be spoken or discussed during a video conference. In at least one embodiment, this mapping include words or phrases that are associated with the user equipment 126, such as part names, part numbers, operation terminology, etc. Each training content 222a-222c may be mapped to one or a plurality of words or phrases. Similarly, words or phrases mapped to training content may be unique to a piece of training content or may be mapped to multiple pieces of training content.

The video-conference-analysis module 234 is configured to receive the audio file (or audiovisual file) of the video conference from the video-conference server 102. The video-conference-analysis module 234 is also configured to analyze the audio file to detect one or more words or phrases that are spoken during the video conference. In some embodiments, the video-conference-analysis module 234 may generate a list of the detected words or phrases. The video-conference-analysis module 234 may also store the number of times each word or phrase is spoken during the video conference, which may also be referred to as the word or phrase usage.

The training selection module 230 receives the list of words or phrases from the video-conference-analysis module 234. The training selection module 230 determines if one or more words or phrases are spoken, used, or reoccurs a threshold number of times, i.e., words or phrases being commonly used during the video conference. In various embodiments, this usage threshold is selected, set, or input by an administrator or supervisor. In response to a word or phrase being used beyond the threshold number of times during the video conference, the training selection module 232 selects training content 222 to provide to the user. In various embodiments, the training selection module 232 coordinates with or uses the training-content manager 230 to select the training content. For example, if the training selection module 232 determines that the word “clutch,” as identified by the video-conference-analysis module 234, is used more than the threshold number of times, then the training selection module 232 can access the training-content manager 230 to determine which training content 222 is mapped to the word “clutch.” Assuming that training content 222c is mapped to the word “clutch,” then the training selection module 232 provides the training content 222c to the user.

In various embodiments, the training selection module 232 may present the selected training content 222 to the user via an audio or video interface (not illustrated) of the training-content server 104. In other embodiments, the training selection module 232 may provide the selected training content 222 to the user device 124a for presentation to the user. In yet other embodiments, the training selection module 232 may provide the selected training content 222 to the video-conference server 102 for presentation to the user via the same video conference that was analyzed by the video-conference-analysis module 234 or another video conference. In further embodiments, the training selection module 232 may provide the selected training content to another computing device, such as user equipment 126 or some other device, for presentation to the user.

As described herein, the training selection module 232 may also utilize sensor data to detect events and select training content based on the detected event, along with the word and phrase usage.

In various embodiments, the user equipment 126 includes one or more sensors (not illustrated). The sensors may include any type of sensor, component, or indicator that can provide information or sensor data regarding some feature, accessory, or operating parameter of the user equipment 126. Examples of sensor data include, but are not limited to, engine RPMs (revolutions per minute), engine temperature, gas or break or clutch pedal position, current gear, changes from one gear to another, various fluid pressures or temperatures, video (e.g., video captured from a camera positioned towards the user/operator), audio (e.g., audio of the engine, audio of the equipment, audio in a cab of the equipment, etc.), button or switch positions, changes in button or switch positions, equipment accessory positions or movements (e.g., blade height on a bulldozer, movement of a backhoe, etc.), status or changes of warning lights, status or changes in gauges or user displays, etc. In some embodiments, the sensor data may also be captured prior to (for a select amount of time) or during started up of the equipment. In other embodiments, the sensor data may be captured for a select amount of time after the equipment is stopped, parked, or turned off. The user equipment is structured or configured to receive the sensor data from the sensors and provide the sensor data to the training-content server 104.

The user-equipment-sensor-management module 236 may receive, store, or otherwise manage the sensor data obtained from the user equipment 126. In various embodiments, the user-equipment-sensor-management module 236 may analyze the sensor data for events, as described herein. In response to an event being detected, the user-equipment-sensor-management module 236 determines the appropriate event type for that event and provides the event type to the training selection module 232. In various embodiments, the user-equipment-sensor-management module 236 may receive, store, or otherwise manage the sensor data and the training selection module 232 may be configured to analyze the sensor data for events and determine the event type.

In some embodiments, the plurality of training content 222a-222c may be stored, categorized, or otherwise managed by event type. For example, a first set of training content may be stored and categorized as training content for a first event, a second set of training content may be stored and categorized as training content for a second event (the second event being different from the first event), and a third set of training content may be stored and categorized as training content for a third event (the third event being different from the first event and the second event). One or more different pieces of training content 222 may be stored for each of a plurality of event type. In some situations, the same training content may be stored for different event types.

Each event type may be selected or defined for a particular event type, a particular sub-event type, a plurality of event types, a plurality of sub-event types, or some combination thereof. The event types is one way of grouping the training content 222a-222c, such that in some embodiments training content can be selected based on the event detected in the sensor data, along with the video conference word and phrase analysis discussed herein. The training content 222a-222c can also be stored or categorized for particular events, a particular piece of equipment, a particular equipment type, a plurality of pieces of equipment, for a plurality of equipment types, or some combination thereof.

In various embodiments, the training selection module 232 selects training content 222 that can train the user of the equipment 126 to improve operation or reduce the likelihood of a repeating event based on the detected event type and the word or phrase usage during the video conference. In some embodiments, the training selection module 232 may also generate equipment modification suggestions based on the detected events, word or phrase usage, or a history of detected events and user behaviors, or some combination thereof.

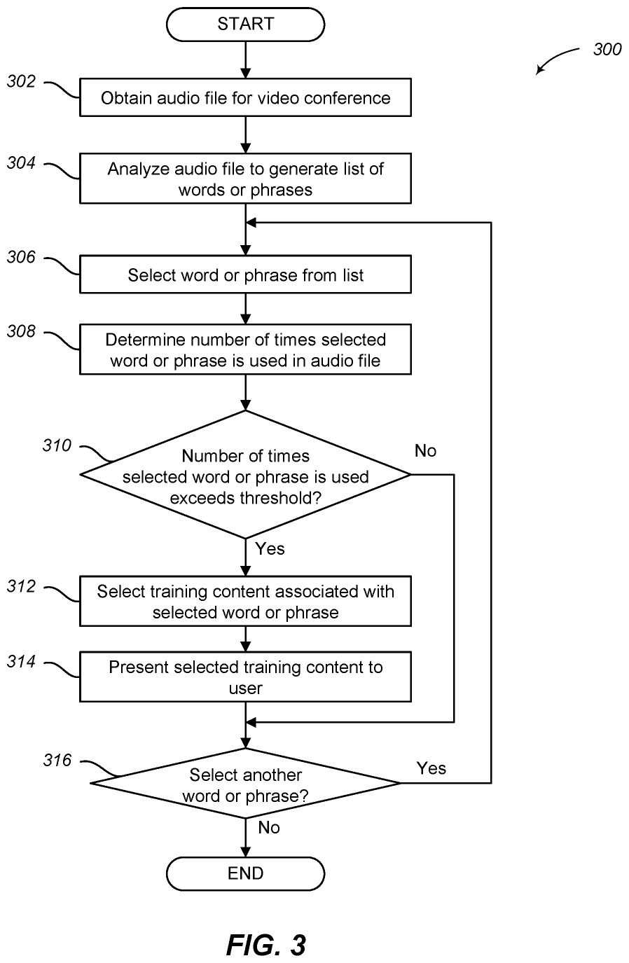

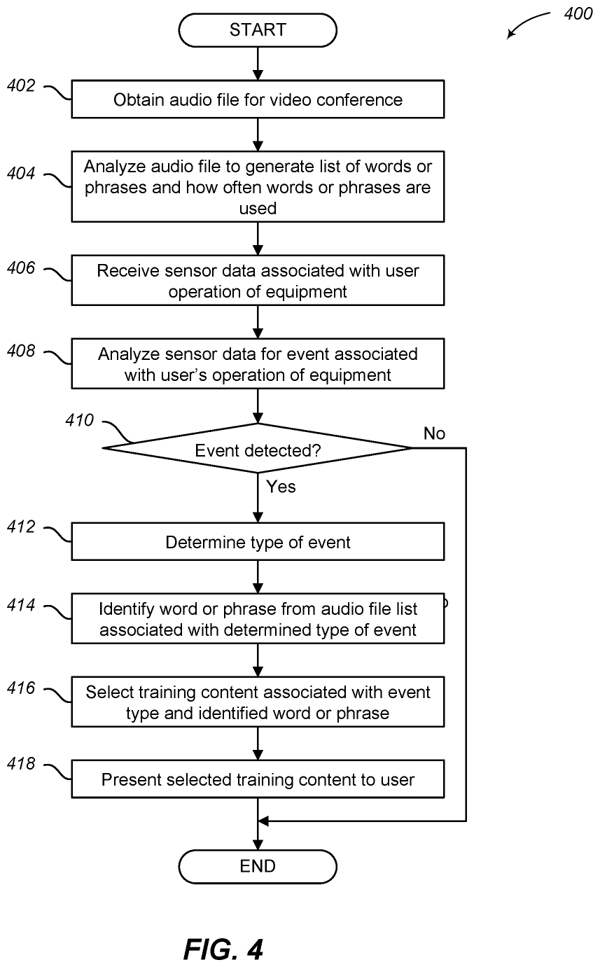

The operation of certain aspects will now be described with respect to FIGS. 3 and 4. In at least one of various embodiments, processes 300 or 400 described in conjunction with FIGS. 3 and 4, respectively, may be implemented by or executed via circuitry or on one or more computing devices, such as training-content server 104 (or a user device 124) in FIG. 1.

FIG. 3 illustrates a logical flow diagram showing one embodiment of a process 300 for analyzing video conference audio data to detect common words and to provide training content to a user in accordance with embodiments described herein.

After a start block, process 300 begins at block 302, where an audio file is obtained for a video conference between two or more participants, as discussed herein.

Process 300 proceeds to block 304, where the audio file is analyzed to generate a list of words or phrases used during the video conference. In various embodiments, one or more speech-recognition techniques may be employed to identify words or phrases spoken during the video conference. In some embodiments, the analysis may include identifying a plurality of separate known words that are spoken during the video conference and adding them to the list. In other embodiments, the analysis may include identifying a plurality of phrases that each contain a plurality of sequential words that are spoken during the video conference and adding them to the list. In yet other embodiments, the analysis may include identifying a plurality of phrases that each contain a plurality of non-sequential words associated a known part of the equipment that are spoken during the video conference and adding them to the list.

In various embodiments, additional speech-recognition techniques may be employed to determine which participant of the video conference spoken the words or phrases. In some embodiments, a presenter of the content for the video conference is detected. Speech-recognition techniques can be performed on the audio file to identify reoccurring words or phrases spoken by the presenter during the video conference. The list of words or phrases is then generated from these identified words or phrases spoken by the presenter. In other embodiments, a user that is operating specific equipment that is a topic of discussion during the video conference may be detected in the audio file. Speech-recognition techniques can be performed on the audio file to identify reoccurring words or phrases spoken by the user during the video conference. The list of words or phrases may then be generated from these identified words or phrases spoken by the user. In various embodiments, a combination of presenter and user spoken words or phrases may be used to generate the list of words or phrases. In some other embodiments, the list may be generated without consideration of the speaker.

Process 300 continues at block 306, where a word or phrase is selected from the list. In some embodiments, the words or phrases in the list are selected and processed based on the word or phrase used or spoken most during the video conference. In other embodiments, the phrases are selected and processed before the words are selected and processed. In yet other embodiments, known words or phrases associated with a topic of discussion during the video conference, such as known words associated with the equipment operated by the user, may be ranked higher than other words or phrases, such that the higher ranked words or phrases are selected and processed first.

Process 300 proceeds next to block 308, where a number of times the selected word or phrase is used in the audio file is determined. In some embodiments, this number is determined as the audio file is analyze and the list of words or phrases is generated. In at least one such embodiment, the list is queried for the number of times the selected word or phrase is used.

Process 300 continues next at decision block 310, where a determination is made whether the number of times the selected word or phrase is used exceeds a threshold. As discussed herein, the threshold may be selected or set by an administrator or supervisor. Moreover, in some embodiments, a plurality of thresholds may be maintained, and a particular threshold may be selected based on a word or phrase being processed, a phrase being processed, a known word being processed, a known phrase being processed, the user speaking, a presenter speaker, etc.

If the selected word or phrase usage exceeds the selected threshold, then process 300 flows to block 312; otherwise, process 300 flows to decision block 316.

At block 312, training content associated with the selected word or phrase is selected. As discussed herein, a plurality of training content may be stored, and each training content may be mapped to one or more words or phrases. If the selected word or phrase matches a word or phrase for a particular piece of training content, then that training content is selected.

In some embodiments, if there is no training content that is associated with the selected word or phrase, then process 300 may loop (not illustrated) from block 312 to block 306 to select another word or phrase from the generated list of words or phrases.

Process 300 proceeds to block 314, where the selected training content is presented to the user. The training content may be audio content, visual content, or audiovisual content. In some embodiments, the training content includes graphical content, such as images, videos, icons, graphics, or other visual content, which is displayed to the user. In other embodiments, the training content includes audio content, such as audio instructions, sounds, audio alerts, or other audible content, which is output to the user via a speaker.

In various embodiment, the training content is presented to the user via a personal computing device, such as a smartphone, laptop computer, etc. In other embodiments, the training content may be presented to the user via an interface built in or integrated into another computing device (e.g., a head unit, infotainment device, or other graphical or audio interface in the user's equipment). Process 300 continues at decision block 316, where a determination is made whether another word or phrase is selected. In some embodiments, another word or phrase is to be selected if a plurality of words or phrases in the generated list of words or phrases are to be processed. In other embodiments, once training content is selected and presented to the user, then another word or phrase may not be selected. If another word or phrase is to be selected, then process 300 loops to block 306 to select another word or phrase; otherwise, process 300 terminates or otherwise returns to a calling process to perform other actions.

Although process 300 shows the training content being selected based on a single selected word or phrase, embodiments are not so limited. In various embodiments, a plurality of words, a plurality of phrases, or a combination of words and phrases, may be selected at block 306 for processing. If one or more of those selected words or phrases, or if an aggregation of those selected words or phrases, is used during the video conference more than the selected threshold, then training content associated with one or more of the selected words or phrases may be selected. For example, the selected words or phrases may be “clutch” and “grinding gears” and the word “clutch” may be used 10 times and the phrase “grinding gears” may be used 15 times. If the selected threshold for either word or phrase is 10, then training content associated with “proper clutch operation” or “how to prevent grinding gears” may be selected and presented to the user.

FIG. 4 illustrates a logical flow diagram showing one embodiment of a process 400 for analyzing video conference audio data to detect common words, as well as analyzing equipment sensor data, to provide training content to a user in accordance with embodiments described herein

After a start block, process 400 begins at block 402, where an audio file is obtained for a video conference between two or more people, as discussed herein. In some embodiments, the participants of the video conference include a user that is operating a piece of equipment and at least one other person. In other embodiments, the participants may include people discussing the user's operation of the equipment, but does not include the user. In various embodiments, block 402 may employ embodiments of block 302 in FIG. 3 to obtain the audio file.

Process 400 proceeds to block 404, where the audio file is analyzed to generate a list of words or phrases used during the video conference. In various embodiments, block 404 may employ embodiments of block 304 in FIG. 3 to analyze the audio file and generate the list of words or phrases spoken during the video conference.

In various embodiments, a plurality of known words or phrases associated with the equipment may be received. In some embodiments, the analysis may include identifying reoccurring words or phrases spoken by a presenter during the video conference that match at least one of the plurality of known words or phrases and generating the list of words or phrases to include the identified reoccurring known words or phrases spoken by the presenter. In other embodiments. In other embodiments, the analysis may include identifying reoccurring words or phrases spoken by the user (that is or was operating the equipment) during the video conference that match at least one of the plurality of known words or phrases and generating the list of words or phrases to include the identified reoccurring known words or phrases spoken by the user.

Process 400 continues at block 406, where sensor data is received. This sensor data is data received from a plurality of sensors associated with the equipment that is being operated by the user. In some embodiments, the sensor data is received before, in parallel with, or after the video conference.

In various, embodiments, the sensor data is collected during the user's operation of the equipment. Examples of such sensor data include, but are not limited to, engine RPMs (revolutions per minute), engine temperature, gas or break or clutch pedal position, current gear, changes from one gear to another, various fluid pressures or temperatures, video (e.g., video captured from a camera positioned towards the user/operator), audio (e.g., audio of the engine, audio of the equipment, audio in a cab of the equipment, etc.), button or switch positions, changes in button or switch positions, equipment accessory positions or movements (e.g., blade height on a bulldozer, movement of a backhoe, etc.), status or changes of warning lights, status or changes in gauges or user displays, etc. In some embodiments, the sensor data may also be captured prior to (for a select amount of time) or during started up of the equipment. In other embodiments, the sensor data may be captured for a select amount of time after the equipment is stopped, parked, or turned off.

Process 400 proceeds next to block 408, where the sensor data is analyzed for an event. As discussed herein, an event may be a defined sensor reading (e.g., sensor data value exceeding a select threshold), trends in one or more types sensor data over time (e.g., maximum blade height becomes less and less over time), relative sensor values between two or more sensors (e.g., RPMs, gas pedal position, and clutch position during a gear shift), or some combination thereof.

In some embodiments, an administrator, owner of the equipment, or other party may select, set, or define the events. In other embodiments, the events may be selected, set, or defined by utilizing one or more machine learning techniques on training sensor data that includes previously known events.

In various embodiments, the analysis of the sensor data may be performed before, in parallel with, or after the analysis of the audio file.

Process 400 continues next to decision block 410, where a determination is made whether an event is detected. If an event is detected in the analysis of the sensor data, then process 400 flows to block 412; otherwise, process 400 terminates or otherwise returns to a calling process to perform other actions.

At block 412, a type of event is determined for the detected event. In various embodiments, the event type identifies category in which the event belongs. For example, the event may be an indication that the clutch position was half-way depressed when shifting from first gear to second gear. The event type for this example event may be “shifting from first gear to second gear.” As another example, the event may be an indication that the RPMs were over a select threshold when shifting from first gear to second gear. Again, the event type may be “shifting from first gear to second gear.” In some embodiments, a sub-event type may be determined from the detected event. For example, the previous examples discussed above the event type of “shifting from first gear to second gear.” This event type may be a sub-event type of a master event type “shifting.”

Process 400 proceeds to block 414, where a word or phrase from the list is identified as being associated with the determined type of event. In some embodiments, the words or phrases in the list are selected and processed (e.g. by comparing the number of times each word or phrase in the list is to a selected threshold) as described above in conjunction with FIG. 3. In other embodiments, a mapping between event types and known words or phrases may be accessed to identify those words or phrases in the list as being associated with the detected event type. In some embodiments, the number of times words or phrases are used during the video conference may also be used to identify commonly used words or phrases associated with the detected event type.

Process 400 continues next to block 416, where training content associated with the identified word or phrase and the determined event type is selected. As discussed herein, a plurality of training content may be stored such that a mapping between the training content and one or more words or phrases is maintained along with an event type, or sub-event or master event. Using the word and phrase mapping, along with the event type, training content is selected that is most closely associated with the event and the reoccurring words or phrases spoken during the video conference. Continuing the previous examples, if the event type for the detected event is “shifting from first gear to second gear” and the word “clutch” is user during the video conference over the selected threshold, then the selected content may be a video that demonstrates the proper way for a person to engage the clutch to shift from first gear to second gear for the equipment being operated by the user.

In some embodiments, the training content that is selected may also be determined based on event itself, along with the event type and the word or phrase usage. For example, if the user only depressed the clutch 75 percent of the way down when shifting from first gear to second gear and discussed that it was difficult to depress the clutch during a video conference, then it may be determined that the user is improperly placing his foot on the clutch and thus needs to be informed of the damage that can be caused by not fully engaging the clutch when shifting from first gear to second gear. In comparison, if the user only depressed the clutch 25 percent of the way down when shifting from first gear to second gear and discussed that he was unfamiliar with that type of equipment, then it may be determined that the user has no idea how to shift gears for that equipment and thus needs a complete training guide on to shift gears for that equipment.

Process 400 proceeds to block 418, where the selected training content is presented to the user. In various embodiments, block 418 may employ embodiments of block 314 in FIG. 3 to present the selected training content to the user.

After block 418, process 400 may terminate or otherwise return to a calling process to perform other actions.

As one example operation of process 400, a driver of a particular type of equipment (e.g., a Class 4-8 truck) operates that equipment without their seat belt plugged in. In some embodiments, the particular driver or operator of the equipment may be identified by having the operator scan a QR code (or other electronic logging or signature devices) inside the cab of the equipment prior to utilization of the equipment. The engine control unit (ECU) of that equipment receives a notification from a sensor associated with the seat belt to indicate that the seat belt has not been plugged in, even though the equipment is being operated by that particular driver. In some embodiments, the ECU can transmit the sensor data to another computing device, such as training-content server 104 in FIG. 1, for further processing. In other embodiments, the ECU can process the sensor data itself. The ECU can trigger a fault code, alert, or warning in response to the event of the seat belt not being plugged in during operation of the equipment. The ECU, or another computing device, can select and send a text message to the driver of the equipment in response to the seat belt event being detected. The text message may include a video or hyperlink to a video highlighting how to connect the seat belt in that particular type of equipment. In some embodiments, the system may monitor the user's access of the training content to determine if the user received the training content and accessed or viewed the training content. Feedback can then be provided to the user, or to an administrator, reporting improvements of the user's behavior in response to consuming the training content.

In various embodiments, blocks 402, 404, and 414 may be optional and not performed, such that the selection and providing of training content is performed without analyzing a video conference to identify words associated with the event.

As another example, an operator of a bulldozer may be pushing controls on the bulldozer to determine or set the blade depth of the shovel as it engages with materials. Sensors associated with the controls, the shovel, or some combination thereof may be monitored to determine how the operator is operating the shovel. If or when the blade depth is too deep, as detected by analyzing the sensor data, the ECU of the bulldozer can detect that event. Such operation of the shovel can cause negative wear and tear on the shovel or other components of the bulldozer. In response to detecting the blade depth event, a video link can then sent to the operator for viewing on proper operation of the blade depth and controls. In this example, the ECU data can be used as a real time training solution focused on the individual operator or user of a piece of equipment. In various embodiments, the training content, such as video content, may be stored in a database, such that it is accessible for local or remote viewing. Such training content can be curated in the field during live scenarios via operators on mobile devices or from staged scenarios created by a particular company or administrator.

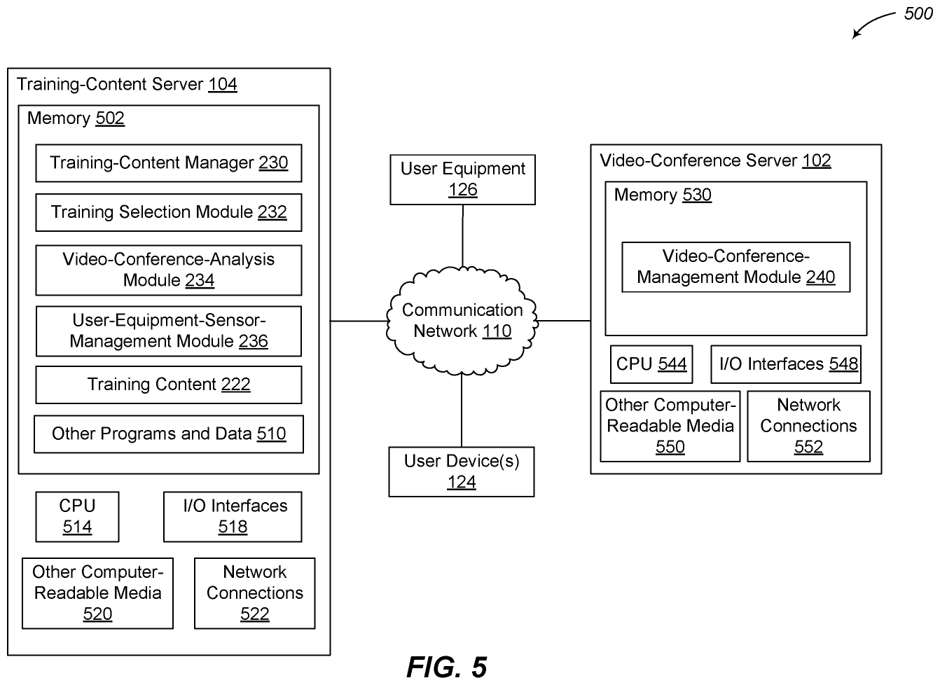

FIG. 5 shows a system diagram that describe various implementations of computing systems for implementing embodiments described herein. System 500 includes a training-content server 104, video-conference server 102, user equipment 126, and user devices 124, which may communicate with one another via network 110.

The training-content server 104 receives video conference data (e.g., an audio file) from the video-conference server 102. The training-content server 104 analyzes the video conference data to identify commonly used words or phrases and to select training content based on those commonly used words or phrases. In some embodiments, the training-content server 104 receives sensor data from the equipment 126. The training-content server 104 can analyze the sensor data to determine if an event has occurred, and select training content based on the event type and the commonly used words or phrases. The training-content server 104 provides the selected training content to the user. One or more special-purpose computing systems may be used to implement the training-content server 104. Accordingly, various embodiments described herein may be implemented in software, hardware, firmware, or in some combination thereof. training-content server 104 may include memory 502, one or more central processing units (CPUs) 514, I/O interfaces 518, other computer-readable media 520, and network connections 522.

Memory 502 may include one or more various types of non-volatile and/or volatile storage technologies. Examples of memory 502 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 502 may be utilized to store information, including computer-readable instructions that are utilized by CPU 514 to perform actions, including embodiments described herein.

Memory 502 may have stored thereon training-content manager 230, training selection module 232, video-conference-analysis module 234, user-equipment-sensor-management module 236, and training content 222. The training-content manager 230 is configured to manage and maintain the training content 222. The video-conference-analysis module 234 is configured to perform embodiments described herein to analyze the video conference data to identify commonly used words or phrases. The user-equipment-sensor-management module 236 is configured to perform embodiments described herein to receive sensor data and to analyze the sensor data for events.

The training selection module 232 is configured to perform embodiments described herein to select training content based on the commonly used words or phrases identified by the video-conference-analysis module 234. In some embodiments, the training selection module 232 may be configured to perform embodiments described herein to select training content based an event being identified in the sensor data by the user-equipment-sensor-management module 236, along with the commonly used words or phrases identified by the video-conference-analysis module 234. The training selection module 232 is also configured to provide the selected training content to the user, such as via user device 124, user equipment 126, video-conference server 102, or some other computing device. In various embodiments, the training selection module 232, or another module (not illustrated), may generate equipment modification suggestions or recommendations based on the sensor data and the commonly used words or phrases.

Although the training-content manager 230, the training selection module 232, the video-conference-analysis module 234, and the user-equipment-sensor-management module 236 are illustrated as separate components, embodiments are not so limited. Rather, one or more computing components or modules may be employed to perform the functionality of the training-content manager 230, the training selection module 232, the video-conference-analysis module 234, and the user-equipment-sensor-management module 236.

Memory 502 may also store other programs and data 510, which may include operating systems, equipment data, event histories for one or more users, sensor data, etc.

In various embodiments, the network connections 522 include transmitters and receivers (not illustrated) to send and receive data as described herein. I/O interfaces 518 may include a video or audio interfaces, other data input or output interfaces, or the like, which can be used to receive or output information to an administrator, among other actions. Other computer-readable media 520 may include other types of stationary or removable computer-readable media, such as removable flash drives, external hard drives, or the like.

Video-conference server 102 maintains or hosts video conferences and provides the video conference data to the training-content server 104, as described herein. One or more special-purpose computing systems may be used to implement the video-conference server 102. Accordingly, various embodiments described herein may be implemented in software, hardware, firmware, or in some combination thereof. Video-conference server 102 may include memory 530, one or more central processing units (CPUs) 544, I/O interfaces 548, other computer-readable media 550, and network connections 552.

Memory 530 may include one or more various types of non-volatile and/or volatile storage technologies similar to memory 502. Memory 530 may be utilized to store information, including computer-readable instructions that are utilized by CPU 544 to perform actions, including embodiments described herein.

Memory 530 may have stored thereon video=conference-management module 240. The video-conference-management module 240 is configured to maintain or host video conferences, as described herein. Memory 530 may also store other programs and data, such as video conference data.

Network connections 552 are configured to communicate with other computing devices, such as training-content server 104, user devices 124, or other computing devices (not illustrated). In various embodiments, the network connections 552 include transmitters and receivers (not illustrated) to send and receive data as described herein. I/O interfaces 548 may include one or more other data input or output interfaces. Other computer-readable media 550 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving, at a computer device, sensor data associated with a user's operation of equipment;
detecting, by the computer device, an event based on an analysis of the sensor data;
identifying, by the computer device, an event type for the event;
obtaining, by the computer device, an audio file of a conference discussing the user's operation of the equipment;
analyzing, by the computer device, the audio file for words or phrases;
generating, by the computer device, a list of words or phrases used during the conference from the analysis of the audio file;
identifying, by the computer device, at least one word or phrase in the list of words or phrases that is used a number of times that exceeds a selected threshold;
selecting, by the computer device, training content associated with the at least one identified word or phrase and the event type; and
presenting the selected training content to the user.

2. The method of claim 1, wherein analyzing the audio file for words or phrases and generating the list of words or phrases comprises:
detecting, by the computer device, a presenter during the conference;
employing, by the computer device, speech recognition on the audio file to identify reoccurring words or phrases spoken by the presenter during the conference; and
generating, by the computer device, the list of words or phrases to include the identified reoccurring words or phrases spoken by the presenter.

3. The method of claim 1, wherein analyzing the audio file for words or phrases and generating the list of words or phrases comprises:
identifying, by the computer device, the user that operated the equipment;
employing, by the computer device, speech recognition on the audio file to identify reoccurring words or phrases spoken by the user during the conference; and
generating, by the computer device, the list of words or phrases to include the identified reoccurring words or phrases spoken by the user.

4. The method of claim 1, wherein generating the list of words or phrases further comprising:
receiving, by the computer device, a plurality of known words or phrases associated with the equipment;
identifying, by the computer device, reoccurring words or phrases spoken by a presenter during the conference that match at least one of the plurality of known words or phrases; and
generating, by the computer device, the list of words or phrases to include the identified reoccurring known words or phrases spoken by the presenter.

5. The method of claim 1, wherein generating the list of words or phrases further comprising:
receiving, by the computer device, a plurality of known words or phrases associated with the equipment;
identifying, by the computer device, reoccurring words or phrases spoken by the user during the conference that match at least one of the plurality of known words or phrases; and
generating, by the computer device, the list of words or phrases to include the identified reoccurring known words or phrases spoken by the user.

6. The method of claim 1, further comprising:
receiving, by the computer device, the selected threshold from an administrator of the conference.

7. The method of claim 1, wherein generating the list of words or phrases further comprises:
identifying, by the computer device, a plurality of separate known words that are spoken during the conference; and
adding, by the computer device, the plurality of separate known words to the list.

8. The method of claim 1, wherein generating the list of words or phrases further comprises:
identifying, by the computer device, a plurality of phrases that each contain a plurality of sequential words that are spoken during the conference; and
adding, by the computer device, the plurality of phrases to the list.

9. The method of claim 1, wherein generating the list of words or phrases further comprises:
identifying, by the computer device, a plurality of phrases that each contain a plurality of non-sequential words associated a known part of the equipment that are spoken during the conference; and
adding, by the computer device, the plurality of phrases to the list.

10. The method of claim 1, further comprising:
generating a suggestion for modifying the equipment based on the event type and the at least one identified word or phrase; and
providing the suggestion to an administrator.

11. A computing device, comprising:
a memory configured to store computer instructions; and
a processor configured to execute the computer instructions to:
obtain an audio file of a conference;
analyze the audio file for words or phrases;
generate a list of words or phrases used during the conference from the analysis of the audio file;
identify at least one word or phrase in the list of words or phrases that is used a number of times that exceeds a select threshold;
select training content associated with the at least one identified word or phrase; and
provide the selected training content to the user.

12. The computing device of claim 11, wherein the processor selects the training content by being configured to further execute the computer instructions to:
receive sensor data associated with a user's operation of equipment;
detect an event based on an analysis of the sensor data;
identify an event type for the event; and
select the training content based on the at least one identified word or phrase and the event type.

13. The computing device of claim 11, wherein the processor analyzes the audio file for words or phrases and generates the list of words or phrases by being configured to further execute the computer instructions to:
detect a presenter during the conference;
employ speech recognition on the audio file to identify reoccurring words or phrases spoken by the presenter during the conference; and
generate the list of words or phrases to include the identified reoccurring words or phrases spoken by the presenter.

14. The computing device of claim 11, wherein the processor analyzes the audio file for words or phrases and generates the list of words or phrases by being configured to further execute the computer instructions to:
identify the user that operated the equipment;
employ speech recognition on the audio file to identify reoccurring words or phrases spoken by the user during the conference; and
generate the list of words or phrases to include the identified reoccurring words or phrases spoken by the user.

15. The computing device of claim 11, wherein the processor generates the list of words or phrases by being configured to further execute the computer instructions to:
receive a plurality of known words or phrases associated with the equipment;
identify reoccurring words or phrases spoken by a presenter during the conference that match at least one of the plurality of known words or phrases; and
generate the list of words or phrases to include the identified reoccurring known words or phrases spoken by the presenter.

16. The computing device of claim 11, wherein the processor generates the list of words or phrases by being configured to further execute the computer instructions to:
receive a plurality of known words or phrases associated with the equipment;
identify reoccurring words or phrases spoken by the user during the conference that match at least one of the plurality of known words or phrases; and
generate the list of words or phrases to include the identified reoccurring known words or phrases spoken by the user.

17. The computing device of claim 11, wherein the processor generates the list of words or phrases by being configured to further execute the computer instructions to:
identify a plurality of separate known words that are spoken during the conference; and
add the plurality of separate known words to the list.

18. The computing device of claim 11, wherein the processor generates the list of words or phrases by being configured to further execute the computer instructions to:
identify a plurality of phrases that each contain a plurality of sequential words that are spoken during the conference; and
add the plurality of phrases to the list.

19. The computing device of claim 11, wherein the processor generates the list of words or phrases by being configured to further execute the computer instructions to:
identify a plurality of phrases that each contain a plurality of non-sequential words associated a known part of the equipment that are spoken during the conference; and
add the plurality of phrases to the list.

20. A non-transitory computer-readable medium storing computer instructions that, when executed by at least one processor, cause the at least one processor to perform actions, the actions comprising:
receiving sensor data associated with a user's operation of equipment;
detecting an event based on an analysis of the sensor data;
identifying an event type for the event;
obtaining an audio file for an inter-computer digital conference discussing the user's operation of the equipment;
analyzing the audio file for words or phrases;
generating a list of words or phrases used during the inter-computer digital conference from the analysis of the audio file;
identifying at least one word or phrase in the list of words or phrases that is used a number of times that exceeds a selected threshold; and
generating a suggestion for modifying the equipment based on the event type and the at least one identified word or phrase.
